(19) United States
(12) Patent Application Publication
(10) Pub. No.: US 2026/0309743 A1
(43) Pub. Date: Oct. 8, 2026

(54) SYSTEM FOR COHERENT WIND SPEED MEASUREMENT USING A BROAD BANDWIDTH LIGHT SOURCE

(71) Applicant: TOBB EKONOMI VE TEKNOLOJI UNIVERSITESI, Ankara (TR)

(72) Inventors: Ibrahim Tuna OZDUR, Ankara (TR); Abdulkadir YENTUR, Ankara (TR)

(21) Appl. No.: 19/108,273

(22) PCT Filed: Sep. 4, 2023
(86) PCT No.: PCT/TR2023/050902

§ 371 Date: Mar. 3, 2025

(30) Foreign Application Priority Data
Sep. 5, 2022 (TR) 2022/013837

(51) Int. Cl. G01P 5/26; G01S 7/481; G01S 17/58; G01S 17/95

(52) U.S. Cl. CPC G01P 5/26; G01S 7/4818; G01S 17/58; G01S 17/95

(57) ABSTRACT

A coherent wind speed measurement system for measuring wind speed at one or a plurality of points based on the principle that light, which is an electromagnetic wave, hits the air molecules and undergoes a Doppler frequency shift. In the disclosed measurement system, a broadband light source is used, and the light emitted from the light source is transmitted to the external environment through a lens system. The light that hits the air molecules in the external environment and is scattered back is combined with the light/lights delayed at one or different times by one or more fiber optical delay lines and transmitted to a frequency shift detection module. According to the frequency shift detected here, a signal processing unit performs wind speed detection.

### FIELD OF THE INVENTION

The present invention relates to a system which enables high-resolution measurement of the wind speed of high-speed vehicles (for example, aircraft) by using a broad-bandwidth light source without being affected by the environmental conditions.

### BACKGROUND OF THE INVENTION

Wind speed measurement systems used in today's aircraft, such as airplanes, are highly sensitive to environmental influences. In the said measurement systems, sensors mounted outside the aircraft are used to measure the wind speed. However, in the said systems, due to environmental factors such as flight altitude, weather conditions, humidity and temperature, the sensors mounted outside the aircraft may ice up. In order to prevent this problem, anti-icing heaters are operated. However, the said anti-icing heaters cause high levels of energy consumption. In addition, the vulnerability of the existing wind speed measurement systems to bird strikes and other environmental influences adversely affects safe travel of aircraft. The high maintenance frequency and low resolution and sensitivity measurement of the sensors used in these systems also constitute the other disadvantages of these measurement systems.

Due to the disadvantages of the state-of-the-art wind speed measurement systems, coherent LIDAR (Light Detection and Ranging) technology can be used as an alternative to the said systems. However, measurement systems with coherent LIDAR technology consist of a number of costly components. Furthermore, the laser light source used in LIDAR technology must have high coherence. However, such laser light sources considerably increase the cost of the system.

### Objects of the Invention

It is an object of the present invention to provide a wind speed measurement system that is prevented from being affected by environmental factors. The system of the present invention, which can be used in high-speed vehicles, especially in airplanes, is positioned inside the aircraft, so that it is less affected by environmental conditions and problems such as icing do not occur.

Another object of the present invention is to provide a wind speed measurement system with lower cost compared to the state-of-the-art systems. The broad bandwidth light source that is used considerably reduces the system costs. This system, which requires much less maintenance compared to the state-of-the-art systems, is both more economical and provides higher reliability. In addition, this system does not use the modulation technique used in the state-of-the-art systems.

A further object of the present invention is to provide a wind speed measurement system that allows wind speed to be measured from desired distances. In the system of the present invention, the wind speed can be measured from one or more distances, and the sensor interrogator can be positioned in different parts of the aircraft with the help of fiber cables.

Yet another object of the present invention is to provide a wind speed measurement system that enables wind speed measurements with much higher resolution.

### SUMMARY OF THE INVENTION

A coherent wind speed measurement system, which is developed to achieve the objects of the present invention and is defined in the first claim and the other claims dependent thereon, comprises at least one light source emitting light in a broad bandwidth; a first optical coupler for splitting the light emitted from the light source into two branches; a fiber optical delay line adapted to delay the light from the first optical coupler in time; a fiber optic circulator comprising a first port, a second port and a third port; a lens system for transmitting the light from the fiber optic circulator to the external environment and for collecting the light scattered back from the air molecules in the external environment and transmitting it to the fiber optic circulator; a second optical coupler combining the light scattered back from the air molecules in the external environment and the light from the fiber optical delay line; a frequency shift detection module for detecting the frequency shift between the lights combined by the second optical coupler; and a signal processing unit adapted to perform wind speed detection according to the frequency shift information received from the frequency shift detection module.

In another embodiment of the invention, the coherent wind speed measurement system according to the invention, which enables wind speed measurement from a plurality of points, comprises at least one light source emitting light in a broad bandwidth; a first optical coupler for splitting the light emitted from the light source into at least three branches; at least two fiber optical delay line adapted to delay the light from the first optical coupler at different times from each other; a fiber optic circulator comprising a first port, a second port and a third port; a lens system for transmitting the light from the fiber optic circulator to the external environment and for collecting the light scattered back from the air molecules and transmitting it to the fiber optic circulator; a third optical coupler for splitting the light incident on its input into at least two branches and comprising one input connected to the third port of the fiber optic circulator and at least two outputs; at least two second optical couplers combining the light from one of the outputs of the third optical coupler with the light from one of the fiber optical delay line; at least two frequency shift detection modules for detecting the frequency shift between the lights combined by the second optical coupler to which it is connected; a signal processing unit adapted to separately perform wind speed detection at different points according to different frequency shift information received from the frequency shift detection modules.

In one embodiment of the invention, the light source can be selected as a light emitting diode (LED), superluminescent diode (SLD) or amplified spontaneous emission (ASE) source.

In one embodiment of the invention, it is a lens system that emits broad bandwidth light coming from the second port to the external environment, without focusing, in a straight manner.

In one embodiment of the invention, the frequency shift detection module is a photodetector or a balanced photodetector.

### DETAILED DESCRIPTION OF THE INVENTION

The coherent wind speed measurement system developed to achieve the objects of the present invention is illustrated in the accompanying figures, in which

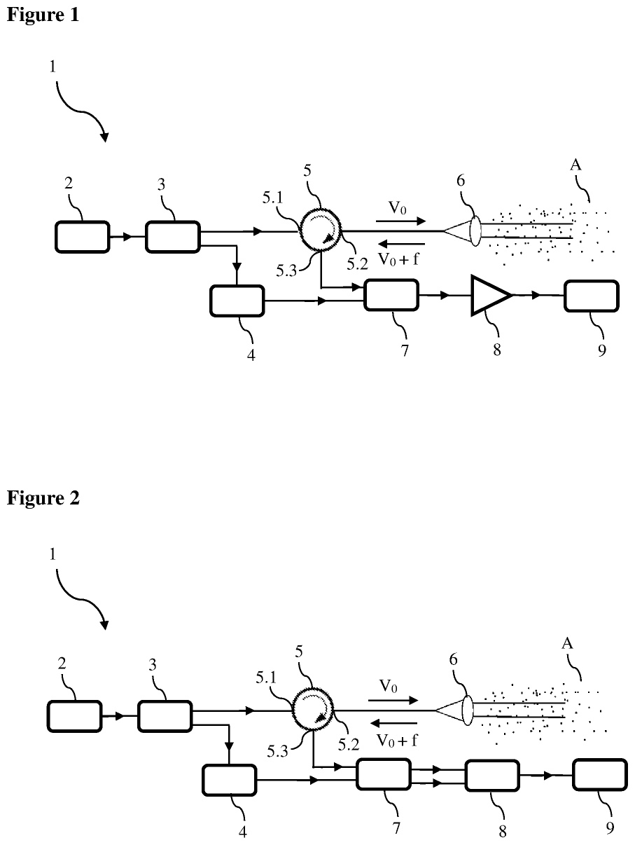

FIG. 1 is a schematic view of the coherent wind speed measurement system according to the first embodiment of the invention.

FIG. 2 is a schematic view of the coherent wind speed measurement system comprising a balanced photodetector.

FIG. 3 is a schematic view of the coherent wind speed measurement system according to the second embodiment of the invention which performs measurement from a plurality of points.

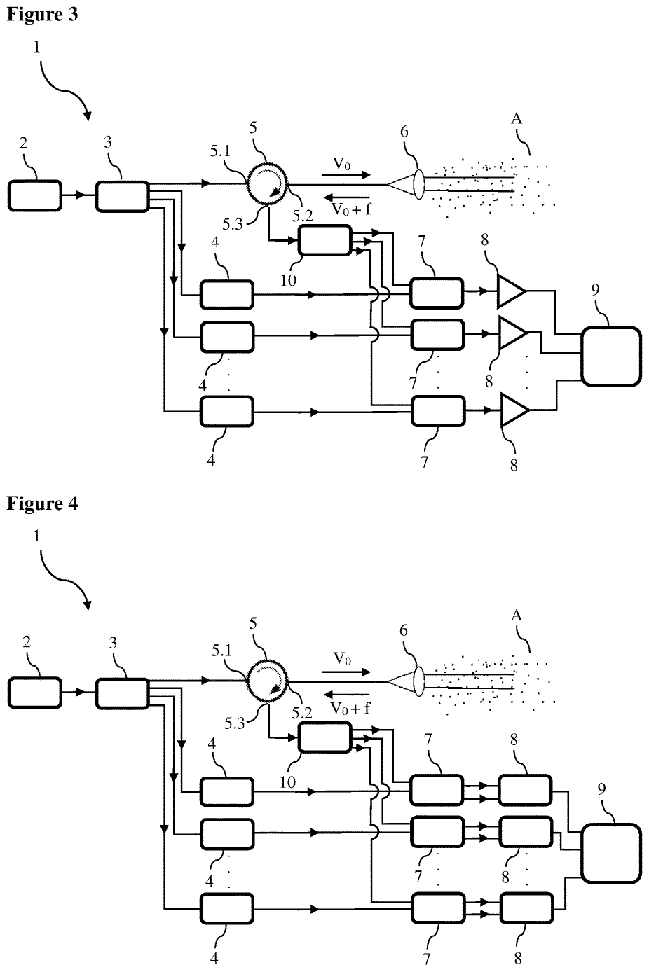

FIG. 4 is a schematic view of the coherent wind speed measurement system which comprises a balanced photodetector and performs measurement from a plurality of points.

The components in the figures are numbered individually and the reference numbers corresponding thereto are given below:
1. Measurement system
2. Light source
3. First optical coupler
4. Fiber optical delay line
5. Fiber optic circulator
5.1. First port
5.2. Second port
5.3. Third port
6. Lens system
7. Second optical coupler
8. Frequency shift detection module
9. Signal processing unit
10. Third optical coupler
A. Air molecules

The coherent wind speed measurement system (1) of the present invention, which enables wind speed detection, basically comprises the following:
at least one light source (2) emitting light in a broad bandwidth;
a first optical coupler (3) comprising an input for receiving the light emitted from the light source (2) and two outputs for splitting the said light into two branches;
a fiber optical delay line (4) which is connected to a first output of the first optical coupler (3) and adapted to delay the light from the first optical coupler (3) in time;
a fiber optic circulator (5) which comprises a first port (5.1), a second port (5.2) and a third port (5.3) and is intended for routing the light from the said first port (5.1) that is connected to a second output of the first optical coupler (3) to the second port (5.2) and the light from the second port (5.2) to the third port (5.3);
a lens system (6) which is connected to the second port (5.2) of the fiber optic circulator (5) and intended for transmitting the light from the second port (5.2) to the external environment and for collecting the light scattered back from the air molecules (A) in the external environment and transmitting it to the second port (5.2);
a second optical coupler (7), which comprises at least one output and two inputs one of which is connected to the third port (5.3) of the fiber optic circulator (5) and the other connected to the fiber optical delay line (4), and combines the light from the third port (5.3) of the fiber optic circulator (5) and the light from the fiber optical delay line (4);
a frequency shift detection module (8), which is connected to the output of the second optical coupler (7), and detects the frequency shift between the lights combined by the second optical coupler (7);
a signal processing unit (9) which is connected to the frequency shift detection module (8) and adapted to perform wind speed detection according to the frequency shift information received from the said module.

The measurement system (1) of the present invention is a system for measuring the wind speed based on the principle that light, which is an electromagnetic wave, hits the air molecules (A) and undergoes a Doppler frequency shift (FIG. 1-2). There are two preferred embodiments of the system of the present invention, where the wind speed can be detected from a single point and from a plurality of points, respectively.

In the first preferred embodiment of the invention, the measurement system (1) comprises at least one light source (2) having a broad bandwidth and emitting a signal at frequency V₀. The said light source (2) may be a light emitting diode (LED), superluminescent diode (SLD), amplified spontaneous emission (ASE) source, etc., however the present invention is not limited to the light sources (2) mentioned herein.

There is provided a first optical coupler (3) at the output of the light source (2). The first optical coupler (3) has one input and two outputs. The input of the first optical coupler (3) is connected to the light source (2). Thus, the signals at frequency V₀ emitted from the light source (2) enter through the input of the first optical coupler (3), are split into two by means of the first optical coupler (3), and the said split signals are transmitted to the outputs of the first optical coupler (3).

At least one fiber optical delay line (4) is connected to a first output of the first optical coupler (3). By means of the said fiber optical delay line (4), the light coming from one of the outputs of the first optical coupler (3) is delayed in time. As explained in detail in the following paragraphs, the light emitted from the light source (2) in the measurement system (1) of the present invention travels a certain path during hitting and being scattered back from the air molecules (A) at different points (e.g. at a distance of 10 cm, 3 m, 70 m . . . ) in the external environment, and a certain amount of time elapses depending on the path taken by the said light. The said time varies according to the distance of the air molecules (A) that cause the light to hit and be scattered back. Therefore, if it is desired to measure the speed with respect to a specific distance, a fiber optical delay line (4) is used, which is pre-adapted to delay the incident light in time with respect to the said distance. Thus, according to the time elapsed along the path taken by the light being emitted from the light source (2) and entering the second optical coupler (7) upon being scattered back from the air molecules (A) located at the distance/point at which the measurement will be conducted in the external environment, the light emitted from the light source (2) and entering the fiber optical delay line (4) is delayed at the corresponding time. Thus, the light traveling through the said two different fiber lines travels the same distance at the same time and reaches the second optical coupler (7), where they are combined. The frequency shift between these combined lights is detected by the frequency shift detection module (8) and accordingly, the speed detection is performed by the signal processing unit (9). Changing the delay time of the signal entering the fiber optical delay line (4) enables the wind speed to be measured at any desired distance.

A fiber optic circulator (5) is connected to a second output of the first optical coupler (3). The said fiber optic circulator (5) has three ports, namely a first port (5.1), a second port (5.2) and a third port (5.3). In general, the fiber optic circulator (5) transmits the signals entering through its first port (5.1) to its second port (5.2) and signals from its second port (5.2) to its third port (5.3).

The first port (5.1) is connected to the second output of the first optical coupler (3) and allows one of the signals split into two by the first optical coupler (3) to enter the fiber optic circulator (5).

A lens system (6) is connected to the second port (5.2) and the signals entering through the first port (5.1) and exiting through the second port (5.2) reach the lens system (6). The lens system (6) emits the broad bandwidth light coming from the second port (5.2) to the external environment (e.g. outside of an air or land vehicle) without focusing, in a straight (collimated) manner. In one embodiment of the invention, the lens system (6) is a collimator lens. The light leaving the lens system (6) hits the air molecules (A) that are at different points and is scattered, and after this scattering, a part of the said light is scattered back at the frequency V0+f. Here f refers to the shift in the frequency of the light (Doppler frequency). This backscattered light is collected back by the lens system (6) and transmitted back to the second port (5.2) of the fiber optic circulator (5). This signal transmitted to the second port (5.2) is transmitted to the third port (5.3) by the fiber optic circulator (5).

There is provided a second optical coupler (7) at the output of the third port (5.3) The said second optical coupler (7) has two inputs and at least one output, and it combines the light coming from two fiber lines to its inputs and transmits it to at least one fiber line at its output. One of the said inputs is connected to the third port (5.3) of the fiber optic circulator (5), while the other input is connected to the fiber optical delay line (4). The second optical coupler (7) combines the signal coming through the third port (5.3) after it is scattered back from the external environment with the signal delayed in time by the fiber optical delay line (4).

The signals combined by the second optical coupler (7) are transmitted to the frequency shift detection module (8), which is a photodetector in one embodiment of the invention. Thus, by using one photodetector, the Doppler frequency shift (f) between the signals (V₀ and V₀+f) entering the said photodetector can be detected (FIG. 1). In another embodiment of the invention, the frequency shift detection module (8) is a balanced photodetector (FIG. 2). In this embodiment, the balanced photodetector comprises two inputs and one output, while the second optical coupler (7) comprises two inputs and two outputs. The signals coming from the outputs of the second optical coupler (7) enter each one of the inputs of the balanced photodetector. Thus, by using one balanced photodetector, frequency shift can be detected without power loss. In addition, the balanced photodetector used in this embodiment is two times (3 dB) more advantageous than the photodetector in terms of signal to noise ratio (SNR).

In all embodiments of the measurement system (1) of the present invention, fiber lines are used for the transmission of the light, which is emitted from the light source (2) and scattered back from the external environment, to the frequency shift detection module (8).

The signals from the frequency shift detection module (8), which is a photodetector or a balanced photodetector, are transmitted via a data cable to a signal processing unit (9), where the wind speed can be detected with high resolution according to the Doppler frequency shift (f) between the signals (delayed and backscattered signals). Speed detection based on the Doppler frequency shift, also referred to as the Doppler effect or Doppler shift, is not described in detail herein since it is disclosed in the state of the art.

In the second preferred embodiment, the speed measurement system (1) of the present invention, which enables wind speed detection at a plurality of points, basically comprises the following:
at least one light source (2) emitting light in a broad bandwidth;
a first optical coupler (3) comprising an input for receiving the light emitted from the light source (2) and at least three outputs for splitting the said light into at least three branches;
at least two fiber optical delay line (4) each of which is connected to a separate output of the first optical coupler (3) and adapted to delay the light from the first optical coupler (3) at different times from each other;
at least one fiber optic circulator (5) which comprises a first port (5.1), a second port (5.2) and a third port (5.3) and is intended for routing the light from the said first port (5.1) that is connected to one of the outputs of the first optical coupler (3) to the second port (5.2) and the light from the second port (5.2) to the third port (5.3);
a lens system (6) which is connected to the second port (5.2) of the fiber optic circulator (5) and intended for transmitting the light from the second port (5.2) to the external environment and for collecting the light scattered back from the air molecules (A) and transmitting it to the second port (5.2);
a third optical coupler (10) for splitting the light incident on its input into at least two branches and comprising one input connected to the third port (5.3) of the fiber optic circulator (5) and at least two outputs;
at least two second optical couplers (7), each of which comprises two inputs and at least one output, where one of the inputs is connected to one of the outputs of the third optical coupler (10) and the other input connected to the output of one of the fiber optical delay lines (4), and combines the light from one of the outputs of the third optical coupler (10) to which they are connected with the light from one of the fiber optical delay lines (4);
at least two frequency shift detection modules (8) each of which is provided at one of the outputs of the second optical coupler (7) and detects the frequency shift between the lights combined by the second optical coupler (7) to which it is connected;
a signal processing unit (9) which is connected to the frequency shift detection modules (8) and adapted to perform wind speed detection at different points separately according to the different frequency shift information received from the said modules.

This second preferred embodiment of the invention, like the first embodiment of the invention, is a system for measuring wind speed based on the principle that light, which is an electromagnetic wave, hits the air molecules (A) and undergoes a Doppler frequency shift (FIG. 3-4). The difference of the second embodiment of the invention from the first embodiment is that wind speed detection can be performed at different points at the same time.

In the second preferred embodiment of the invention, the measurement system (1) comprises at least one light source (2) having a broad bandwidth and emitting a signal at frequency V₀. The said light source (2) may be a light emitting diode (LED), superluminescent diode (SLD), amplified spontaneous emission (ASE), etc., however the present invention is not limited to the light sources (2) mentioned herein.

There is provided a first optical coupler (3) at the output of the light source (2). The first optical coupler (3) has one input and at least three outputs. The input of the first optical coupler (3) is connected to the light source (2). Thus, the signals at frequency V₀ emitted from the light source (2) enter through the input of the first optical coupler (3) and are split into two by means of the first optical coupler (3). The said split signals are transmitted to the outputs of the first optical coupler (3). The number of outputs of the first optical coupler (3) can be increased depending on the number of different points where wind speed is desired to be measured. For example, while a first optical coupler (3) with four outputs is used for wind speed measurement from three different points, a first optical coupler (3) with more outputs can be used depending on the number of points where the measurement will be conducted.

A separate fiber optical delay line (4) is connected to each output of the first optical coupler (3). By means of the said fiber optical delay line (4), the light coming from one of the outputs of the first optical coupler (3) is enabled to be delayed at different times from each other. In other words, as explained above, the light emitted from the light source (2) travels a certain path during hitting and being scattered back from the air molecules (A) in the external environment, and a certain amount of time elapses depending on the path taken by the said light. The said time varies according to the distance of the air molecules (A) that cause the light to hit and be scattered back. Therefore, in case it is desired to measure the speed with respect to specific distances, fiber optical delay line (4) is used, which are pre-adapted to delay the incident light in time with respect to the said distances. Thus, according to the time elapsed along the path taken by the light coming out of the light source (2), being scattered back from the air molecules (A) at the distances/points where measurement will be conducted in the external environment and reaching the second optical coupler (7), the lights coming out of the light source (2) and entering the fiber optical delay line (4) are delayed at corresponding times. In this way, wind speed can be measured simultaneously from as many different points as the number of fiber optical delay line (4). Changing the delay time of the signal entering the fiber optical delay line (4) enables the wind speed to be measured at desired distances.

A fiber optic circulator (5) is connected to another output of the first optical coupler (3), where the output referred to as another output is the output of the first optical coupler (3) which is not connected to the fiber optical delay line (4). The said fiber optic circulator (5) has three ports, namely a first port (5.1), a second port (5.2) and a third port (5.3). In general, the fiber optic circulator (5) transmits the signals entering through its first port (5.1) to its second port (5.2) and signals from its second port (5.2) to its third port (5.3).

The first port (5.1) is connected to an output of the first optical coupler (3) which is not connected to the fiber optical delay line (4) and allows one of the signals split into a plurality of branches by the first optical coupler (3) to enter the fiber optic circulator (5).

A lens system (6) is connected to the second port (5.2) and the signals entering through the first port (5.1) and exiting through the second port (5.2) reach the lens system (6). The lens system (6) emits the broad bandwidth light coming from the second port (5.2) to the external environment (e.g. outside of an air vehicle) without focusing, in a straight (collimated) manner. In one embodiment of the invention, the lens system (6) is a collimator lens. The light leaving the lens system (6) hits the air molecules (A) and is scattered, and after this scattering, a part of the said light is scattered back at the frequency V0+f. This backscattered light is collected back by the lens system (6) and transmitted back to the second port (5.2) of the fiber optic circulator (5) via the same fiber line. This signal, which is scattered back and transmitted to the second port (5.2) via the lens system (6), is transmitted to the third port (5.3) by the fiber optic circulator (5).

There is provided a third optical coupler (10) at the output of the third port (5.3). The said third optical coupler (10) comprises one input and at least two outputs and splits the light incident on its input into as many different branches as the number of outputs it comprises. The number of outputs of the third optical coupler (10) may increase depending on the number of points where wind speed measurements will be conducted. For example, a third optical coupler (10) with three outputs can be used if wind speed measurements are conducted at three different points.

There are provided at least two second optical couplers (7) at the output of the third optical coupler (10). The second optical couplers (7) comprise two inputs and at least one output. One of the inputs of each second optical coupler (7) is connected to one of the outputs of the third optical coupler (10) while the other input is connected to the output of one of the fiber optical delay lines (4). Each second optical coupler (7) combines the signal received via the third optical coupler (10) after being scattered back from the external environment and the signal delayed in time by the fiber optical delay line (4) to which it is connected.

There is provided a frequency shift detection module (8) at the output of each second optical coupler (7) and the signals combined by the second optical couplers (7) are transmitted to the frequency shift detection modules (8). In one embodiment of the invention, the frequency shift detection module (8) is a photodetector (FIG. 3). Thus, by using as many photodetectors as the number of points where measurement will be conducted, the Doppler frequency shifts (f) between the signals (V₀ and V₀+f) entering the said photodetectors can be detected separately. In another embodiment of the invention, the frequency shift detection module (8) is a balanced photodetector (FIG. 4). In this embodiment, the balanced photodetectors comprise two inputs and one output, while the second optical couplers (7) comprise two inputs and two outputs. The signals coming from the outputs of the second optical couplers (7) reach the inputs of one of the balanced photodetectors to which each second optical coupler (7) is connected.

In all embodiments of the measurement system (1) of the present invention, fiber lines are used for the transmission of the light, which is emitted from the light source (2), and scattered back from the external environment, to the frequency shift detection module (8).

The signals from the frequency shift detection modules (8), which are photodetectors or balanced photodetectors, are transmitted via a data cable to a signal processing unit (9). In the signal processing unit (9), wind speed at different points can be detected with high resolution according to the Doppler frequency shifts (f) between the said signals (signals delayed at different times and signals scattered from the external environment).

1. A coherent wind speed measurement system which enables wind speed detection, the system comprising:
at least one light source emitting light in a broad bandwidth;
a first optical coupler comprising an input for receiving the light emitted from the light source and two outputs for splitting the said light into two branches;
a fiber optical delay line which is connected to a first output of the first optical coupler and adapted to delay the light from the first optical coupler in time;
a fiber optic circulator which comprises a first port a second port and a third port and is intended for routing the light from the said first port that is connected to a second output of the first optical coupler to the second port and the light from the second port to the third port
a lens system which is connected to the second port of the fiber optic circulator and intended for transmitting the light from the second port to the external environment and for collecting the light scattered back from the air molecules in the external environment and transmitting it to the second port;
a second optical coupler, which comprises at least one output and two inputs one of which is connected to the third port of the fiber optic circulator and the other connected to the fiber optical delay line and combines the light from the third port of the fiber optic circulator and the light from the fiber optical delay line;
a frequency shift detection module which is connected to the output of the second optical coupler and detects the frequency shift between the lights combined by the second optical coupler and
a signal processing unit which is connected to the frequency shift detection module and adapted to perform wind speed detection according to the frequency shift information received from the said module.

2. Coherent wind speed measurement system according to claim 1, wherein the at least one light source is selected from a group consisting of a light emitting diode (LED), a superluminescent diode (SLD), and an amplified spontaneous emission (ASE) source.

3. Coherent wind speed measurement system according to claim 1, wherein the lens system emits the broad bandwidth light coming from the second port to the external environment without focusing, in a collimated manner.

4. Coherent wind speed measurement system according to claim 1, wherein the lens system is a collimator lens.

5. Coherent wind speed measurement system according to claim 1, wherein the frequency shift detection module is a photodetector.

6. Coherent wind speed measurement system according to claim 1, wherein the frequency shift detection module is a balanced photodetector.

7. A coherent wind speed measurement system, which enables wind speed detection, the system comprising:
at least one light source emitting light in a broad bandwidth;
a first optical coupler comprising an input for receiving the light emitted from the light source and at least three outputs for splitting the said light into at least three branches;
at least two fiber optical delay lines, each of which is connected to a separate output of the first optical coupler and adapted to delay the light from the first optical coupler at different times from each other;
at least one fiber optic circulator which comprises a first port, a second port and a third port and is intended for routing the light from the said first port that is connected to one of the outputs of the first optical coupler to the second port and the light from the second port to the third port;
a lens system which is connected to the second port of the fiber optic circulator and intended for transmitting the light from the second port to the external environment and for collecting the light scattered back from the air molecules and transmitting it to the second port;
a third optical coupler for splitting the light incident on its input into at least two branches and comprising one input connected to the third port of the fiber optic circulator and at least two outputs;
at least two second optical couplers, each of which comprises two inputs and at least one output, where one of the inputs is connected to one of the outputs of the third optical coupler and the other input connected to the output of one of the fiber optical delay lines, and combines the light from one of the outputs of the third optical coupler with the light from one of the fiber optical delay lines;
at least two frequency shift detection modules each of which is provided at one of the outputs of the second optical coupler and detects the frequency shift between the lights combined by the second optical coupler to which it is connected;
a signal processing unit which is connected to the frequency shift detection modules and adapted to perform wind speed detection at different points separately according to the different frequency shift information received from the said modules.

8. Coherent wind speed measurement system according to claim 7, wherein the at least one light source is selected from a group comprising consisting of a light emitting diode (LED), a superluminescent diode (SLD) and an amplified spontaneous emission (ASE) source.

9. Coherent wind speed measurement system according to claim 7, wherein the lens system emits the broad bandwidth light coming from the second port to the external environment without focusing, in a collimated manner.

10. Coherent wind speed measurement system according to claim 7, wherein the lens system is a collimator lens.

11. Coherent wind speed measurement system according to claim 7, wherein the frequency shift detection module is a photodetector.

12. Coherent wind speed measurement system according to claim 7, wherein the frequency shift detection module is a balanced photodetector.
